(19) United States
(12) Patent Application Publication
(10) Pub. No.: US 2021/0295218 A1
(43) Pub. Date: Sep. 23, 2021

(54) ACCOMMODATION AREA MANAGEMENT DEVICE

(71) Applicant: HONDA MOTOR CO., LTD., Tokyo (JP)

(72) Inventors: Junpei NOGUCHI, Saitama (JP); Gaku SHIMAMOTO, Saitama (JP); Yuta TAKADA, Tokyo (JP); Ryoma TAGUCHI, Tokyo (JP); Shogo KOBAYASHI, Saitama (JP)

(73) Assignee: HONDA MOTOR CO., LTD., Tokyo (JP)

(21) Appl. No.: 17/203,197

(22) Filed: Mar. 16, 2021

(30) Foreign Application Priority Data
Mar. 19, 2020 (JP) 2020-050302

(51) Int. Cl. G06Q 10/02; G06Q 10/06; G06Q 30/02; G07B 15/02

(52) U.S. Cl. CPC G06Q 10/02; G07B 15/02; G06Q 30/0284; G06Q 10/06314

(57) ABSTRACT

An accommodation area management device which manages an accommodation area for accommodating a moving body includes a storage unit configured to store a scheduled accommodation time of the moving body in the accommodation area and a reservation reception unit configured to accept a usage reservation for the moving body during the scheduled accommodation time.

### CROSS-REFERENCE TO RELATED APPLICATIONS

This application is based upon and claims the benefit of priority from prior Japanese patent application No. 2020-050302, filed on Mar. 19, 2020, the entire contents of which are incorporated herein by reference.

### TECHNICAL FIELD

The present invention relates to an accommodation area management device.

### BACKGROUND ART

In order to solve chronic shortage of parking lots, a technique for promoting introduction of a hybrid parking lot where both a contracted vehicle and a general vehicle can be parked is disclosed (see, for example, JP-A-2002-074431).

However, in the related art, there is room for improvement from a viewpoint of effectively utilizing a moving body accommodated in an accommodation area. For example, in the related art, a moving body accommodated in an accommodation area for a long period of time is left as it is, and thus there is room for improvement in utilization of this moving body.

### SUMMARY OF INVENTION

The invention provides an accommodation area management device which makes it possible to effectively utilize a moving body accommodated in an accommodation area.

According to an aspect of the invention, there is provided an accommodation area management device which manages an accommodation area for accommodating a moving body. The accommodation area management device includes a storage unit configured to store a scheduled accommodation time of the moving body in the accommodation area and a reservation reception unit configured to accept a usage reservation for the moving body during the scheduled accommodation time.

According to the invention, it is possible to effectively utilize the moving body accommodated in the accommodation area.

### BRIEF DESCRIPTION OF DRAWINGS

FIG. 1 is a diagram illustrating an example of a configuration of a vehicle system according to an embodiment.

FIG. 2 is a diagram illustrating an example of a parking lot managed by the parking lot management device of the embodiment.

FIG. 3 is a diagram illustrating an example of a configuration of the parking lot management device of the embodiment.

FIG. 4 is a diagram illustrating an example of a parking space information table.

FIG. 5 is a diagram illustrating an example of a parking reservation information table.

FIG. 6 is a diagram illustrating an example of a parking time scheduler.

FIG. 7 is a flowchart illustrating an example of a series of processes performed by the parking lot management device of the embodiment.

### DESCRIPTION OF EMBODIMENT

Hereinafter, an embodiment of an accommodation area management device of the invention will be described with reference to the accompanying drawings. In the following embodiments, an example in which a moving body in the invention is a vehicle and an accommodation area in the invention is a parking lot will be described. Further, in the following embodiment, an example in which the accommodation area management device of the invention is used as a parking lot management device for managing a parking lot will be described.

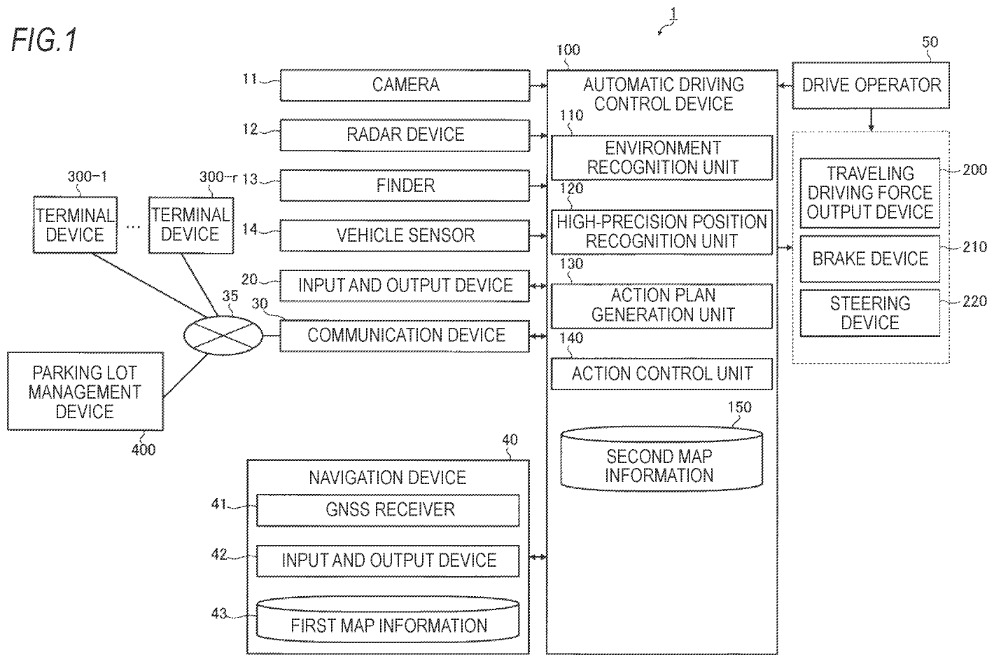

First, the vehicle of the embodiment will be described. In FIG. 1, a vehicle system 1 is mounted on a vehicle. A vehicle (hereinafter, also referred to as a vehicle M) equipped with the vehicle system 1 is an automobile including a drive source and wheels (for example, two wheels, three wheels, or four wheels) including driving wheels driven by the power of the drive source. As the drive source of the vehicle M, for example, an electric motor, an internal combustion engine (for example, a gasoline engine), or a combination of the electric motor and the internal combustion engine is used.

Further, as will be described in detail below, the vehicle M can be used by a plurality of users. In the embodiment, the user (hereinafter, also simply referred to as a user) of the vehicle M is not limited to a person who manages or owns the vehicle M and uses the vehicle M but also includes a person who borrows the vehicle M from the manager of the vehicle M and uses the vehicle M and a person who temporarily uses the vehicle M on behalf of the manager of the vehicle M or a person who rents the vehicle M. The vehicle M may be one which is managed and owned by a company and then rented to an individual or one which is managed and owned by an individual and then rented to another individual.

The vehicle system 1 has a function capable of performing all driving tasks related to the vehicle M, at least within a limited specific area (for example, in parking lot PA described below). Here, the driving task is, for example, a real-time driving function necessary for maneuvering the vehicle M such as controlling a left-right movement (steering) of the vehicle M, controlling a forward-backward movement (acceleration, deceleration), and monitoring the driving environment, and a tactical function such as planning a traveling track.

As illustrated in FIG. 1, the vehicle system 1 includes, for example, a camera 11, a radar device 12, a finder 13, a vehicle sensor 14, an input and output device 20, a communication device 30, a navigation device 40, a drive operator 50, an automatic driving control device 100, the traveling driving force output device 200, a brake device 210, a steering device 220. Each of those devices is communicably connected to each other by a wired or wireless communication network. The communication network connecting each of those devices is, for example, Controller Area Network (CAN).

The camera 11 is a digital camera which photographs the periphery (for example, in front of vehicle M) of the vehicle M and outputs image data obtained by the photographing to the automatic driving control device 100. The radar device 12 is, for example, a radar device using radio waves in a millimeter wave band, detects a position of an object in the vicinity (for example, in front of, behind, and to the side of vehicle M) of the vehicle M, and outputs the detection result to the automatic driving control device 100.

The finder 13 is, for example, Laser Imaging Detection and Ranging (LIDAR). The finder 13 uses a predetermined laser beam to measure the distance to an object (target object) around (for example, in front of, behind, and to the side of vehicle M) the vehicle M and outputs the measurement result to the automatic driving control device 100.

The vehicle sensor 14 includes, for example, a vehicle speed sensor which detects the speed of the vehicle M, an acceleration sensor which detects the acceleration of the vehicle M, an angular velocity sensor which detects the angular velocity around a vertical axis of the vehicle M, an orientation sensor which detects the orientation of the vehicle M, and the like. Further, the vehicle sensor 14 includes a radio wave intensity sensor which detects the radio wave intensity (that is, the communication environment) used by the communication device 30 for communication. The vehicle sensor 14 outputs the detection result of each sensor to the automatic driving control device 100 or the like.

The input and output device 20 includes an output device which outputs various kinds of information and an input device which accepts various input operations. The output device of the input and output device 20 is, for example, a display which displays based on a processing result of the automatic driving control device 100. The output device may be a speaker, a buzzer, an indicator light, or the like. Further, the input device of the input and output device 20 is, for example, a touch panel or an operation button (key, switch, or the like) which outputs an operation signal corresponding to an input operation received from a user to the automatic driving control device 100.

The communication device 30 is wirelessly connected to a network 35 and communicates with another device provided outside the vehicle system 1 via the network 35. The network 35 includes, for example, a mobile communication network, a Wi-Fi network, Bluetooth (registered trademark), Dedicated Short Range Communication (DSRC), and the like.

The communication device 30 communicates with, for example, terminal devices 300-1 to 300-n carried by each user who can use the vehicle M. The terminal devices 300-1 to 300-n are, for example, smartphones and tablet terminals, which are electronic devices connected to the network 35 and provided with a display for displaying various kinds of information, a touch panel for receiving input operations, and the like. Hereinafter, any terminal device among the terminal devices 300-1 to 300-n may be referred to as a terminal device 300-i.

The communication device 30 also communicates with a parking lot management device 400 which manages the parking lot PA in which the vehicle M can be parked. The parking lot PA and the parking lot management device 400 will be described below.

The navigation device 40 includes a Global Navigation Satellite System (GNSS) receiver 41 and an input and output device 42. Further, the navigation device 40 includes a storage device (not illustrated) such as a hard disk drive (hereinafter, also referred to as HDD) and a flash memory and first map information 43 is stored in this storage device. The first map information 43 is, for example, information representing a road shape by a link indicating a road and a node connected by the link. Further, the first map information 43 may include information representing the curvature of the road and the Point Of Interest (POI).

The GNSS receiver 41 identifies the latitude and longitude of a point where the vehicle M is located as the position of the vehicle M based on the signal received from the GNSS satellite. Further, the navigation device 40 may specify or correct the position of the vehicle M by an Inertial Navigation System (INS) using the output of the vehicle sensor 14.

The input and output device 42 includes an output device which outputs various kinds of information and an input device which accepts various input operations. The output device of the input and output device 42 is, for example, a display which displays (for example, displays a route on a map described below) based on the processing result of the navigation device 40. Further, the input device of the input and output device 42 is, for example, a touch panel or an operation button (key, switch, or the like) which outputs an operation signal corresponding to the input operation received from a user to the navigation device 40. The input and output device 42 may be shared with the input and output device 20.

Although detailed description is omitted, the navigation device 40 determines, for example, a route (hereafter, also referred to as the route on the map) from the position of the vehicle M specified by the GNSS receiver 41 to a destination input by a user with reference to the first map information 43. Then, the navigation device 40 guides a user on the determined route on the map by the input and output device 42. Further, the navigation device 40 is configured to be able to output information indicating the position of the specified vehicle M and the determined route on the map to the automatic driving control device 100, or the like.

Some or all of the functions of the navigation device 40 may be realized by the terminal device 300-i. Further, some or all of the functions of the navigation device 40 may be realized by an external server (navigation server) capable of communicating with the vehicle system 1 by the communication device 30 or the like.

The drive operator 50 is various operators such as an accelerator pedal, a brake pedal, a shift lever, a steering wheel, a deformed steering wheel, and a joystick. The drive operator 50 is provided with a sensor which detects the amount of operation or the presence or absence of operation on the drive operator 50. The detection result by the sensor of the drive operator 50 is output to a part or all of the automatic driving control device 100, the traveling driving force output device 200, the brake device 210, and the steering device 220.

The traveling driving force output device 200 outputs a traveling driving force (torque) for the vehicle M to travel to the driving wheels. The traveling driving force output device 200 includes, for example, an electric motor and an electric motor Electronic Control Unit (ECU) which controls the electric motor. The electric motor ECU controls the electric motor based on the detection result by the sensor of the drive operator 50 (for example, the accelerator pedal) and the control information from the automatic driving control device 100. Further, when the vehicle M includes an internal combustion engine or a transmission as a drive source, the traveling driving force output device 200 may include an internal combustion engine or a transmission and an ECU for controlling the internal combustion engine or the transmission.

The brake device 210 includes, for example, a brake caliper, a cylinder which transmits hydraulic pressure to the brake caliper, an electric motor which generates hydraulic pressure in the cylinder, and a brake ECU. Based on the detection result by the sensor of the drive operator 50 (for example, the brake pedal) and the control information from the automatic driving control device 100, the brake ECU controls the electric motor of the brake device 210 so that the brake torque corresponding to the braking operation is output to each wheel.

The steering device 220 includes, for example, a steering ECU and an electric motor. The electric motor of the steering device 220, for example, applies a force to the rack and pinion mechanism to change the direction of the steering wheel. Based on the detection result by the sensor of the drive operator 50 (for example, the steering wheel) and the control information from the automatic driving control device 100, the steering ECU drives the electric motor of the steering device 220 to change the direction (that is, the steering angle) of the steering wheels.

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like to which each functional unit (for example, high-precision position recognition unit 120) of the automatic driving control device 100 can access and second map information 150 is stored in this storage device.

The second map information 150 is more accurate map information than the first map information 43. The second map information 150 includes, for example, information indicating the center of a lane, information indicating a lane boundary line (for example, a road lane marking), and the like. Further, the second map information 150 may include road information, traffic regulation information, address information, facility information, telephone number information, and the like.

Further, the second map information 150 may be updated at any time by the communication device 30 communicating with another device. For example, when the vehicle M enters the parking lot PA, the communication device 30 receives information (hereafter, also referred to as in-parking-lot map information) indicating the lane in the parking lot PA, the position of each parking space, and the like from the parking lot management device 400. Then, the automatic driving control device 100 updates the second map information 150 so as to incorporate the received in-parking-lot map information into the second map information 150. As a result, the automatic driving control device 100 can specify the position of each parking space PS in the parking lot PA with reference to the second map information 150. Further, the second map information 150 may be updated by the communication device 30 communicating with a server or the like which distributes the map information.

The environment recognition unit 110 performs sensor fusion processing on information acquired by a part or all of the camera 11, the radar device 12, and the finder 13, in such a manner that the environment recognition unit 110 recognizes an object around the vehicle M and recognizes its position. The environment recognition unit 110 recognizes, for example, an obstacle, a road shape, a traffic light, a guardrail, a utility pole, a surrounding vehicle (including traveling conditions such as speed and acceleration and parking conditions), a lane mark, a pedestrian, and the like and recognizes their positions.

Referring to the position of the vehicle M specified by the navigation device 40, the detection result by the vehicle sensor 14, the image taken by the camera 11, the second map information, and the like, the high-precision position recognition unit 120 recognizes the detailed position and attitude of the vehicle M. The high-precision position recognition unit 120 recognizes, for example, the traveling lane in which the vehicle M is traveling or recognizes the relative position and attitude of the own vehicle with respect to the traveling lane. Further, the high-precision position recognition unit 120 also recognizes, for example, the position of the vehicle M in the parking lot PA. The information indicating the position of the vehicle M recognized by the high-precision position recognition unit 120 is used for various processes by the automatic driving control device 100.

The action plan generation unit 130 generates an action plan for the vehicle M. Specifically, the action plan generation unit 130 generates a target track on which the vehicle M will travel in the future as an action plan of the vehicle M. The target track is, for example, information in which points (track points) to be reached by the vehicle M are arranged for each predetermined traveling distance (for example, about several [m]). Further, the target track may include information on speed elements such as the target speed and the target acceleration of the vehicle M at each predetermined time or at each track point. The action plan generation unit 130 generates an action plan according to the instructions of the parking lot management device 400 received by the communication device 30, for example.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based on the speed element associated with the target track and controls the steering device 220 according to a curvature degree of the target track.

Each functional unit included in the automatic driving control device 100 is realized, for example, by the Central Processing Unit (CPU) executing a predetermined program (software). Further, a part or all of the functional units of the automatic driving control device 100 may be realized by hardware such as Large Scale Integration (LSI), Application Specific Integrated Circuit (ASIC), Field-Programmable Gate Array (FPGA), Graphics Processing Unit (GPU), and for example, the storage device for storing the second map information 150 and the high-precision position recognition unit 120 may be realized by a Map Positioning Unit (MPU). Further, a part or all of the functional units included in the automatic driving control device 100 may be realized by the cooperation of software and hardware.

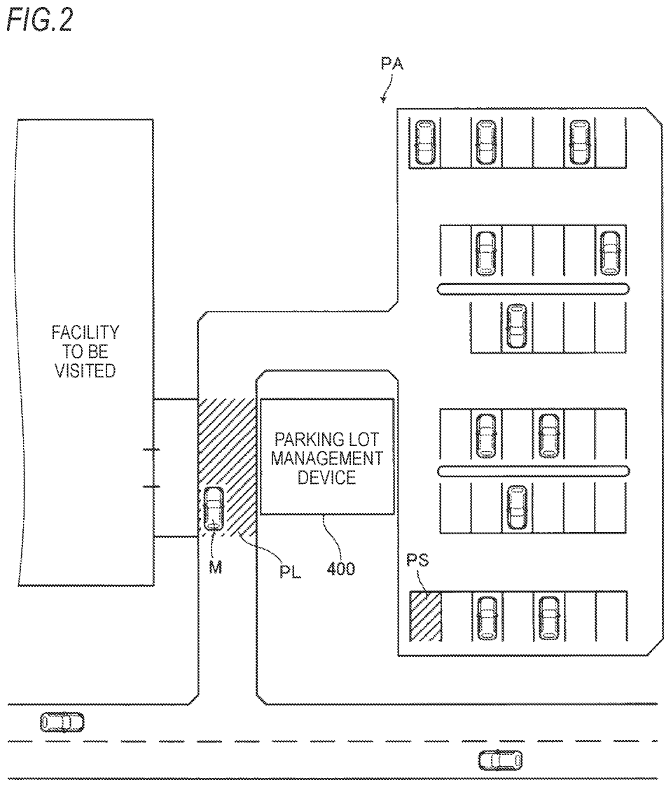

Next, the parking lot PA where the vehicle can be parked and the parking lot management device 400 for managing the parking lot PA will be described. As illustrated in FIG. 2, the parking lot PA is an automatic valet parking type parking lot attached to a visited facility to be visited by a user. The parking lot PA includes a plurality of parking spaces PS where a vehicle (for example, vehicle M) can be parked and a platform PL provided right before the plurality of parking spaces PS.

The parking lot management device 400 is a device (computer) which manages the parking lot PA. For example, the parking lot management device 400 determines the parking position of the vehicle entering the parking lot PA or instructs the vehicle to move to the determined parking position.

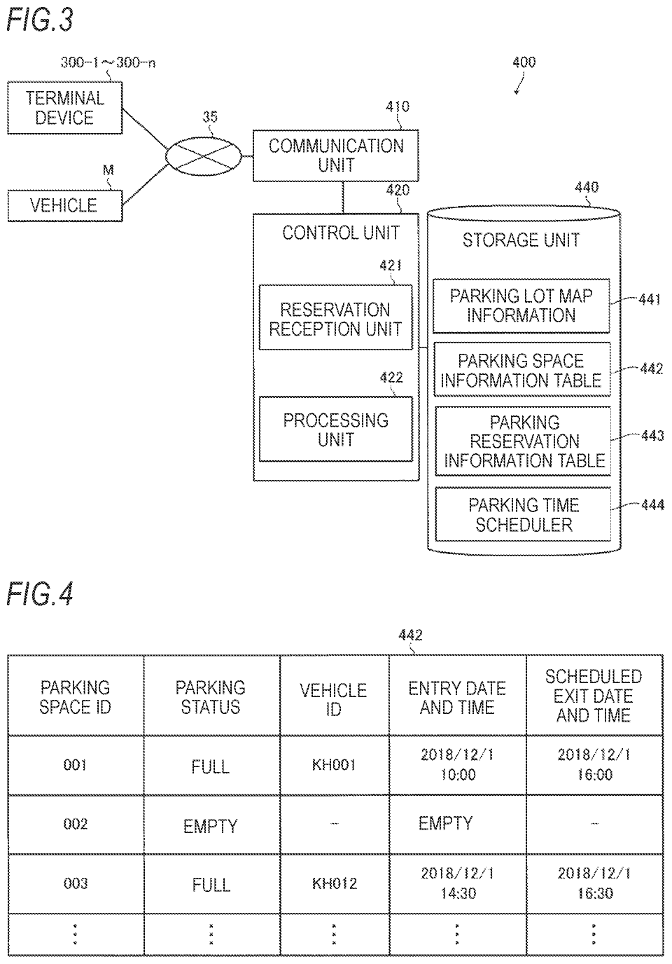

More specifically, the parking lot management device 400 includes a communication unit 410, a control unit 420, and a storage unit 440, as illustrated in FIG. 3. The communication unit 410 and the control unit 420 are realized, for example, by the CPU executing a predetermined program (software) stored in advance. Further, a part or all of these functional units may be realized by hardware such as LSI, ASIC, FPGA, and GPU or may be realized by collaboration between software and hardware.

Further, the storage unit 440 is realized by, for example, an HDD or a flash memory and stores parking lot map information 441, a parking space information table 442, a parking reservation information table 443, a parking time scheduler 444, and the like. Further, the parking lot management device 400 is configured to be able to output the stored contents of the storage unit 440 (for example, parking reservation information table 443) to the outside via the network 35 or the like.

The parking lot map information 441 is information which geometrically represents the structure of the parking lot PA and includes, for example, information indicating the coordinates (positions) of each parking space PS. As illustrated in FIG. 4, the parking space information table 442 stores, for example, information in which the parking space ID, the parking status, and the vehicle ID are associated with each other. Here, the parking space ID is an identifier (identification information) which identifies each parking space PS. The parking status indicates whether any vehicle is parked in the corresponding parking space PS. In the parking status, for example, when a vehicle is parked, it is set to “full”, and when no vehicle is parked, it is set to “empty”. The vehicle ID is an identifier of each vehicle as described above. In the parking space information table 442, the vehicle ID is stored in association with the parking space PS whose parking status is “full” and indicates the vehicle parked in the parking space PS.

Further, as illustrated in FIG. 4, the parking space information table 442 may further store information indicating the date and time (that is, the entry date and time when the vehicle enters each parking space PS) when the vehicle is parked in each parking space PS, information indicating the scheduled exit date and time when the vehicle is scheduled to exit (leave) from each parking space PS.

As illustrated in FIG. 5, the parking reservation information table 443 stores, for example, the parking space ID and the parking reservation information in association with each other. Further, the parking reservation information table 443 may store a plurality of parking reservation information in association with each parking space ID. The parking space ID is an identifier of each parking space PS as described above. The parking reservation information includes information indicating the vehicle ID which identifies each vehicle and a scheduled parking time by which the vehicle is scheduled to be parked.

For example, in the case of the example illustrated in FIG. 5, as a first parking reservation information (parking reservation information 1) corresponding to the parking space ID “001”, information indicating the vehicle ID “KH001” and the scheduled parking time “2018/12/1 10:00-16:00” is stored in the parking reservation information table 443. This shows that the vehicle with a vehicle ID “KH001” is scheduled to be parked in the parking space PS with a parking space ID “001” during the time period “2018/12/1 10:00-16:00”.

Here, an example will be described in which a user of the vehicle M uses the parking lot PA, that is, the vehicle M is parked in the parking lot PA. Prior to using the parking lot PA, the user makes a parking reservation for the parking lot PA using the navigation device 40, the terminal device 300-i, or the like. This “user” is not limited to the owner or manager of the vehicle M, but includes, for example, a person (for example, a concierge) who performs procedures such as parking reservation on behalf of the owner of the vehicle M. In this parking reservation, the user inputs the vehicle ID of the vehicle M, the scheduled parking time for parking the vehicle M in the parking lot PA, and the like. Those input pieces of information are sent to the parking lot management device 400. The parking lot management device 400 refers to the received vehicle ID and information indicating the scheduled parking time and the parking reservation information table 443 and determines whether there is a parking space PS where the vehicle M can be parked during the scheduled parking time. Then, when there is a parking space PS where the vehicle M can be park parked, the parking lot management device 400 stores the received vehicle ID and information indicating the scheduled parking time in the parking reservation information table 443 in association with the parking space PS and notifies the user that the parking reservation has been accepted.

After that, when the scheduled parking time comes, the user rides the vehicle M on the platform PL and gets off from the vehicle M at the platform PL. After the user gets off the vehicle M, the vehicle M automatically drives and executes a self-propelled entry event to move to a predetermined parking space PS in the parking lot PA. For example, when the user gets off the vehicle M at the platform PL, the user sends a request for starting the self-propelled entry event to the parking lot management device 400 by his or her own terminal device 300-i or the like. Upon receiving this start request, the parking lot management device 400 refers to the parking reservation information table 443, identifies the parking space PS where the vehicle M is to enter, and instructs the vehicle M to move to the parking space PS. Further, the parking lot management device 400 may also determine a route on which the vehicle M should travel to the parking space PS where the vehicle M is to enter and instruct the vehicle M to move along the route. Upon receiving the instruction from the parking lot management device 400, the vehicle M moves to the parking space PS specified by the parking lot management device 400 while sensing with the camera 11, radar device 12, or finder 13, and the like.

In addition, when leaving the parking lot PA, the vehicle M automatically drives from the parked parking space PS and executes a self-propelled exit event to move to the platform PL. For example, when a user causes the vehicle M to exit from the parking lot PA, he or she sends a request for starting the self-propelled exit event to the parking lot management device 400 by his or her own terminal device 300-i or the like. The parking lot management device 400 instructs the vehicle M to move to the platform PL. Further, the parking lot management device 400 may also determine a route on which the vehicle M should travel to the platform PL and instruct the vehicle M to move along the route. The vehicle M which has received the instruction from the parking lot management device 400 moves to the platform PL while sensing with the camera 11, radar device 12, or finder 13, and the like. Then, the user gets on the vehicle M at the platform PL and exits from the parking lot PA.

By the way, there are various purposes for a user to park the vehicle M in the parking lot PA and the length of the scheduled parking time also varies depending on the purpose. For example, the vehicle M may be parked in the parking lot PA for a short period of time such as one hour, or the vehicle M may be parked in the parking lot PA for a long period of half a day or longer. It is not preferable that the vehicle M is parked in the parking lot PA for a long time, that is, the vehicle M is left in the parking lot PA for a long time from the viewpoint of the utilization efficiency of the vehicle M.

Therefore, the parking lot management device 400 stores the scheduled parking time of the vehicle M in the parking lot PA and accepts the usage reservation of the vehicle M by another user within the scheduled parking time. This makes it possible to rent the vehicle M to other users at the time when the vehicle M was left in the parking lot PA in the past. As a result, the utilization efficiency of the vehicle M can be improved, and thus effective utilization of the vehicle M is possible. In addition, car sharing such as using the vehicle M by a plurality of users can be promoted.

Specifically, the storage unit 440 of the parking lot management device 400 stores the scheduled parking time of the vehicle M in the parking lot PA by the parking reservation information table 443 or the like. Further, the control unit 420 of the parking lot management device 400 includes a reservation reception unit 421. The reservation reception unit 421 accepts a vehicle M usage reservation from another user (for example, another user's terminal device 300-i) during the scheduled parking time of the vehicle M via the communication unit 410. The reservation reception unit 421 receives, for example, a usage reservation from another user using a part of the scheduled parking time of the vehicle M as the usage reservation time. Another user makes the usage reservation by, for example, specifying a start date and time and an end date and time of the usage reservation time.

The usage reservation received by the reservation reception unit 421 is stored and managed by, for example, the parking time scheduler 444 of the storage unit 440. The parking time scheduler 444 manages, for example, the scheduled parking time of the vehicle M and the usage reservation time of the vehicle M by another user in association with each other. The parking time scheduler 444 may be incorporated in the parking reservation information table 443 or may be provided in the form of another table independent of the parking reservation information table 443.

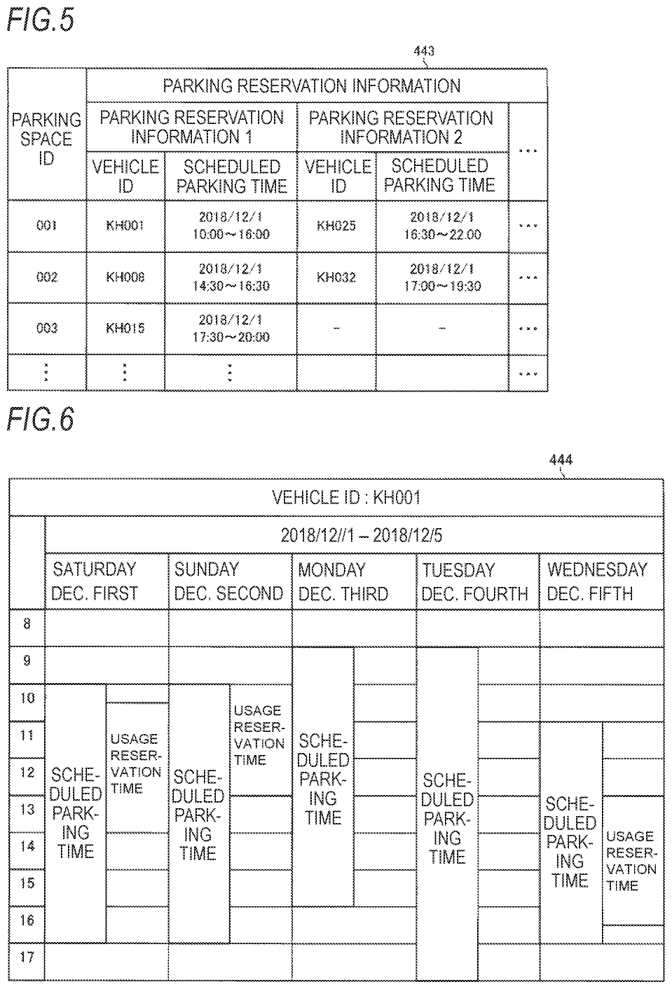

FIG. 6 illustrates an example of a matrix-type parking time scheduler 444 having a date axis in a row direction and a time axis in a vertical direction for the vehicle M (for example, a vehicle with vehicle ID “KH001”). For example, the parking time scheduler 444 stores the scheduled parking time for each date of the vehicle M obtained by referring to the parking reservation information table 443 and the usage reservation time for each date of the vehicle M received by the reservation reception unit 421. Needless to say, the format for storing the scheduled parking time and the usage reservation time is not limited to this.

When the scheduled parking time of the vehicle M is registered (for example, stored in parking reservation information table 443) by, for example, a user who owns or manages the vehicle M, the reservation reception unit 421 accepts a usage reservation of the vehicle M from a user other than that user. As a result, the user who owns or manages the vehicle M can rent the vehicle M to another user when he or she does not use the vehicle M, and thus it is possible to effectively use the vehicle M.

That is, the usage reservation of the vehicle M can be a usage reservation from a second user different from a first user who owns or manages the vehicle M. Examples of the first user include a maintenance company which manages the vehicle M and the like, in addition to a company and an individual who own the vehicle M. In addition, examples of the second user include individuals and companies wishing to use the vehicle M. By accepting the usage reservation from such a second user, it is possible to increase the number of users of the vehicle M and improve the utilization efficiency of the vehicle M.

Further, from the viewpoint of safe operation of the vehicle M, it is desirable to set a predetermined restriction on the taking of the vehicle M from the parking lot PA by the second user who is not the first user who owns or manages the vehicle M. Therefore, the control unit 420 of the parking lot management device 400 includes, for example, a processing unit 422. The processing unit 422 allows the second user to take out the vehicle M from the parking lot PA only when the usage reservation of the vehicle M exists. More specifically, when the second user requests a self-propelled exit event for the vehicle M, for example, the processing unit 422 moves the vehicle M to the platform PL in response to the request of the self-propelled exit event only when the usage reservation of the vehicle M exists. In this way, the safe operation of the vehicle M is possible by allowing the second user, who is not the first user, to take out the vehicle M from the parking lot PA on the condition that there is a usage reservation.

In addition, by providing an incentive to the first user who permits the rental (sharing) of the vehicle owned or managed by him or her, it is considered that the rental of the vehicle can be promoted. Therefore, the parking lot management device 400 may apply a lower usage fee for the use of the parking lot PA to the first user who permits the use of the vehicle by the second user based on the usage reservation than to the first user who does not allow the use of the vehicle by the second user based on the usage reservation. In this way, by applying a lower usage fee (for example, monthly fee for parking lot PA) to the first user who permits the rental (sharing) of the vehicle owned or managed by him or her than to the first user who does not allow it, it is possible to improve the convenience of the second user while suppressing the cost of using the parking lot PA by the first user.

Further, it is desirable that the scheduled parking time of the vehicle M is set by the first user who owns or manages the vehicle M as described above. As a result, the scheduled parking time can be set with respect for the intention of the first user who owns or manages the vehicle M, and thus the utilization efficiency of the vehicle M can be improved while avoiding a decrease in convenience of the first user.

Further, the parking lot management device 400 may allow the second user to exit from the parking lot PA a plurality of times when the second user is using the vehicle M. As a result, the second user can appropriately exit from the parking lot PA as needed when using the vehicle M, so that the convenience of the second user can be improved. In this case, the parking lot management device 400 may apply a uniform usage fee for the use of the parking lot PA no matter how many times the second user exits from the parking lot PA or may be a fee according to the number of exits.

Further, it is desirable that the parking lot management device 400 does not accept the usage reservation of the vehicle M by a third user when the second user is using the vehicle M. Here, the third user is a user different from the first user and the second user. By doing so, it is possible to prevent duplication of vehicle M usage reservations by different users. Further, by doing so, it is possible to suppress the lending of the vehicle M from the second user to the third user.

In addition, the processing unit 422 may further perform various processes for managing the parking lot PA. For example, the processing unit 422 may determine the parking position of the vehicle entering the parking lot PA or may instruct the vehicle to move to the determined parking position. Furthermore, for example, when it becomes necessary to change (that is, repark) the parking position of the parked vehicle in the parking lot PA, the processing unit 422 may determine a new parking position with reference to the parking space information table 442 or the like and send a suitable route to the parking position to the vehicle performing the repark by using the communication unit 410. In this case, in the vehicle which received the route, the action plan generation unit 130 generates an action plan (for example, a target track) based on the route and the action control unit 140 controls the vehicle to act according to this action plan.

Processing Flow

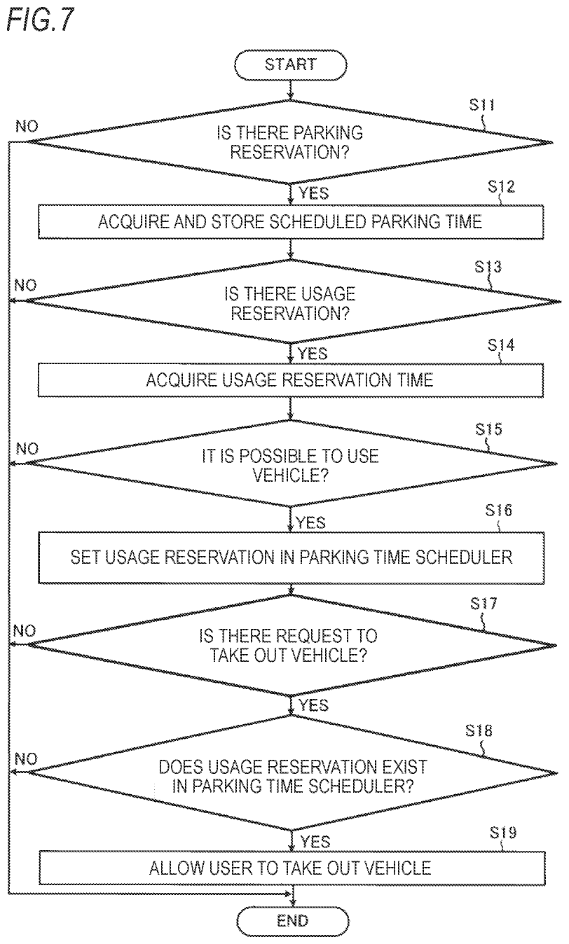

Next, an example of a series of processes performed by the parking lot management device 400 will be described with reference to FIG. 7. The parking lot management device 400, for example, repeats the processes illustrated in FIG. 7 at a predetermined cycle.

First, the parking lot management device 400 determines whether a parking reservation for the vehicle M is made by the first user who owns or manages the vehicle M (Step S11). When there is no parking reservation (NO in Step S11), the parking lot management device 400 ends the process illustrated in FIG. 7. When there is a parking reservation (YES in Step S11), the parking lot management device 400 acquires the scheduled parking time of the parking reservation and stores the acquired scheduled parking time in the parking reservation information table 443, the parking time scheduler 444, or the like (Step S12).

By the processing of Step S11 and Step S12, each time the parking lot management device 400 accepts a parking reservation, the parking reservation information table 443 or the like can store the scheduled parking time according to the parking reservation. In addition, when the parking reservation of the vehicle M is “0”, that is, when no vehicle M is scheduled to be parked in the parking lot PA, the parking lot management device 400 does not need to perform the processes after Step S13 described below.

Next, the parking lot management device 400 determines whether the second user who wishes to use the vehicle M has made a usage reservation of the vehicle M (Step S13). When there is no usage reservation (NO in Step S13), the parking lot management device 400 ends the process illustrated in FIG. 7. When there is a usage reservation (YES in Step S13), the parking lot management device 400 acquires the usage reservation time of the received usage reservation (Step S14) and determines whether the vehicle M can be used by the received usage reservation, that is, whether the usage reservation time falls within the scheduled parking time (see FIG. 6) (Step S15). When the vehicle M cannot be used, that is, when the usage reservation time does not fall within the scheduled parking time (NO in Step S15), the parking lot management device 400 ends the processes illustrated in FIG. 7. It is possible to consider the case where the end of the scheduled parking time of the first user is near, as the case where the usage reservation time does not fall within the scheduled parking time.

When the vehicle M can be used, that is, when the usage reservation time falls within the schedule parking time, the parking lot management device 400 formally accepts the usage reservation by the reservation reception unit 421, sets and stores the usage reservation (usage reservation time) in the parking time scheduler 444 (Step S16).

Next, the parking lot management device 400 determines whether there is a request (for example, a request to start a self-propelled exit event of vehicle M) to take out the vehicle M (Step S17). When there is no request to take out the vehicle M (NO in Step S17), the parking lot management device 400 ends the process illustrated in FIG. 7.

When there is a request for taking out the vehicle M (YES in Step S17), the parking lot management device 400 determines whether a usage reservation corresponding to the request for taking out the vehicle M exists in the parking time scheduler 444 (Step S18). Then, only when the usage reservation exists, the parking lot management device 400 allows the user who sends the request for taking out the vehicle M, that is, the second user, to take out the vehicle M from the parking lot PA (Step S19). In Step S19, for example, the parking lot management device 400 moves the vehicle M to the platform PL and sends the virtual key information necessary for starting and unlocking the vehicle M to the terminal device 300-i of the second user who sends the request for taking out the vehicle M. As a result, the second user can use the vehicle M by using the terminal device 300-i which has received the virtual key information. Further, it is desirable that the virtual key can temporarily (for example, only during the usage reservation time) use the vehicle M.

Further, as described above, whether the first user allows the use of own vehicle by the second user based on the usage reservation may be set in advance for the parking lot management device 400. Further, the first user may be inquired at a predetermined timing whether to allow the second user to use own vehicle based on the usage reservation. Here, the predetermined timing can be, for example, the timing when the first user makes a parking reservation or the timing before and after the first user gets off the vehicle M at the platform PL. Then, the parking lot management device 400 may apply a lower usage fee for the use of the parking lot PA to the first user who permits the use of own vehicle than to the first user who does not permit the use of own vehicle (application of discounted rate).

In the embodiment described above, the vehicle is used in response to the so-called vehicle usage reservation. However, the idea of the invention is not limited to such an embodiment and is also applied to a moving body (for example, a robot) including a vehicle. That is, the invention also includes a case where the target accommodation position is changed in the accommodation area for accommodating the so-called moving body. Under this idea, “parking” is extended to the concept of “stop” and the “parking lot management device” of the embodiment is extended to the concept of “accommodation area management device”. In addition, since the “parking area” is an area which occupies a part of the parking lot, which is the accommodation area, it is extended to the concept of “partial accommodation area”.

Although the embodiment for carrying out the invention is described above using the embodiment, the invention is not limited to the embodiment and various modifications and substitutions can be made without departing from the gist of the invention.

Although the embodiment for carrying out the invention is described above using the embodiment, the invention is not limited to the embodiment and various modifications and substitutions can be made without departing from the gist of the invention.

In addition, at least the following matters are described in this specification. The components and the like corresponding to those in the embodiment described above are shown in parentheses, but the invention is not limited thereto.

(1) An accommodation area management device (parking lot management device 400) which manages an accommodation area (parking lot PA) for accommodating a moving body (vehicle M), including:

a storage unit (storage unit 440) configured to store a scheduled accommodation time of the moving body in the accommodation area; and

a reservation reception unit (reservation reception unit 421) configured to accept a usage reservation for the moving body during the scheduled accommodation time.

According to (1), since the usage reservation for the moving body is accepted during the scheduled accommodation time of the moving body in the accommodation area, the moving body accommodated in the accommodation area can be effectively utilized.

(2) The accommodation area management device according to (1), where

the usage reservation is a usage reservation from a second user different from a first user who owns or manages the moving body.

According to (2), by accepting the usage reservation from the second user, the number of users of the moving body can be increased and the usage efficiency of the moving body can be improved.

(3) The accommodation area management device according to (2), where

the device is configured to allow the second user to take out the moving body from the accommodation area only when the usage reservation exists.

According to (3), the safe operation of the moving body is possible by permitting the second user to take out the moving body from the accommodation area on condition that the usage reservation is made.

(4) The accommodation area management device according to (3), where

the device is configured to allow the second user to exit from the accommodation area a plurality of times while the second user uses the moving body.

According to (4), while the second user uses the moving body, the second user is allowed to exit from the accommodation area a plurality of times. Therefore, the convenience of the second user can be improved.

(5) The accommodation area management device according to any one of (2) to (4), where

the device is configured to manage the accommodation area such that the usage reservation by a third user different from the first user and the second user is not accepted while the second user uses the moving body.

According to (5), w % bile the second user uses the moving body, the usage reservation for the moving body by the third user different from the first user and the second user is not accepted. As a result, it is possible to prevent duplication of usage reservations for the moving body by different users.

(6) The accommodation area management device according to any one of (2) to (5), where

the device is configured to manage the accommodation area such that a lower usage fee for the use of the accommodation area is applied to the first user who permits the use by the second user based on the usage reservation than to the first user who does not allow the use by the second user based on the usage reservation

According to (6), it is possible to improve the convenience of the second user while suppressing the cost of using the accommodation area of the first user.

(7) The accommodation area management device according to any one of (1) to (6), where

the scheduled accommodation time is set by the first user who owns or manages the moving body.

According to (7), the scheduled accommodation time can be set with respect for the intention of the first user.

What is claimed is:

1. An accommodation area management device which manages an accommodation area for accommodating a moving body, comprising:
a storage unit configured to store a scheduled accommodation time of the moving body in the accommodation area; and
a reservation reception unit configured to accept a usage reservation for the moving body during the scheduled accommodation time.

2. The accommodation area management device according to claim 1, wherein
the usage reservation is a usage reservation from a second user different from a first user who owns or manages the moving body.

3. The accommodation area management device according to claim 2, wherein
the device is configured to allow the second user to take out the moving body from the accommodation area only when the usage reservation exists.

4. The accommodation area management device according to claim 3, wherein
the device is configured to allow the second user to exit from the accommodation area a plurality of times while the second user uses the moving body.

5. The accommodation area management device according to claim 2, wherein
the device is configured to manage the accommodation area such that the usage reservation by a third user different from the first user and the second user is not accepted while the second user uses the moving body.

6. The accommodation area management device according to claim 2, wherein
the device is configured to manage the accommodation area such that a lower usage fee for the use of the accommodation area is applied to the first user who permits the use by the second user based on the usage reservation than to the first user who does not allow the use by the second user based on the usage reservation.

7. The accommodation area management device according to claim 1, wherein
the scheduled accommodation time is set by the first user who owns or manages the moving body.
